(19) United States
(12) Patent Application Publication
(10) Pub. No.: US 2016/0329958 A1
(43) Pub. Date: Nov. 10, 2016

(54) METHOD, DEVICE AND COMPUTER STORAGE MEDIUM FOR AIR INTERFACE SYNCHRONIZATION SIGNALING PROCESSING

(71) Applicant: ZTE CORPORATION, Shenzhen, Guangdong (CN)

(72) Inventors: Wei Gou, Shenzhen (CN); Xiaogang Han, Shenzhen (CN); Focai Peng, Shenzhen (CN); Yajun Zhao, Shenzhen (CN)

(21) Appl. No.: 15/108,080

(22) PCT Filed: Oct. 30, 2014
(86) PCT No.: PCT/CN2014/089901

§ 371 Date: Jun. 24, 2016

(30) Foreign Application Priority Data
Dec. 26, 2013 (CN) 201310733751.X

(51) Int. Cl. H04B 7/26; H04W 4/06; H04W 56/00

(52) U.S. Cl. CPC H04B 7/2696; H04W 56/0015; H04W 4/06

(57) ABSTRACT

A method, device, and computer storage medium for air interface synchronization signaling processing are described in embodiments of the present invention. A cell obtains a location of a subframe used for air interface synchronization monitoring, and sends the air interfaces synchronization signaling of the cell at the location of the subframe, wherein the subframe used for air interface synchronization monitoring is a subframe of the cell. Other cells receive a reference signal used for air interface synchronization from the cell at the subframe.

### TECHNICAL FIELD

The present disclosure relates to the technology of wireless communications, and more particularly to, a method and a device for processing an air interface synchronization signaling, and a computer storage medium.

### BACKGROUND

In an LTE (Long Term Evolution) system, synchronization solutions for a small cell and a macro cell are being researched currently. The synchronization solutions may be used to perform a synchronization process between small cells, and may be further used in other scene, including synchronization of cells for different operators. A small cell receives from a macro cell a reference signal for an air interface synchronization, so as to calculate time offset from the macro cell, thus timing can be calibrated and synchronization between the small cell and the macro cell can be achieved.

Currently, a manner based on Multicast Broadcast Single Frequency Network (MBSFN) sub-frames is determined as a basis of the air interface synchronization. The basic principles of the manner based on MBSFN are as follows.

The small cell monitors a cell reference signal (CRS) sent by the macro cell so as to synchronize with the macro cell, and the small cell also configures a sub-frame of the CRS received from the macro cell (a monitoring sub-frame) as a sub-frame of the MBSFN and sends the sub-frame of the MBSFN to a subordinate user equipment (UE). Therefore, an influence on transmission, measurement or the like of a physical downlink shared channel (PDSCH) of the subordinate UE of the small cell is minimized.

In a deployment scenario of a small cell, especially a high density small cell, some small cells, which need to perform monitoring, tend not to receive from a macro cell a reference signal for air interface synchronization, but need to use a small cell adjacent to themselves as a source cell, and receive from the small cell a reference signal for air interface synchronization so as to synchronize with this small cell. However, due to a certain timing difference between this small cell and the macro cell, especially, a timing difference between a multi-hop source cell and the macro cell may be greater; therefore, it is recommended by some companies that a parameter, a layer number which is used to describe a synchronization level of a source cell can be introduced. For example, it is defined that a macro cell is a source cell of a small cell 1 and a layer number of this macro cell is 0, the small cell 1 would directly receive from this macro cell a reference signal for interface synchronization. Furthermore, a layer number of the small cell 1 is 1, when the small cell 1 is used as a source cell of a small cell 2; a layer number of the small cell 3 is 2, when the small cell 2 is used as a source cell of a small cell 3, and so forth. It is considered that source cells located at the same layer are of no timing difference.

A small cell is often deployed in a high density manner, a concept of a small cell cluster is introduced such that the small cell is managed conveniently. Small cells which are subordinates of one macro cell belong to several different small cell clusters based on geographical locations of the small cells. Since there may be some interference between small cell clusters, different small cell clusters need to be evaded when a small cell selects a source cell.

However, currently there is no technical support for sending or receiving a monitoring air interface synchronization signaling.

### SUMMARY

It is provided a method, a device for processing an air interface synchronization signaling, and a computer storage medium according to embodiments of the present disclosure, thus a small cell can receive an air interface synchronization signaling while it performs monitoring.

The technical solutions of the embodiments of the present disclosure are achieved as follows.

It is provided a method for processing an air interface synchronization signaling, which includes:

a cell obtains a position of a sub-frame for monitoring air interface synchronization, and sends an air interface synchronization signaling of the cell at the position of the sub-frame; where the sub-frame for monitoring air interface synchronization is a sub-frame of the cell, other cells receive a reference signal for air interface synchronization send by the cell in the sub-frame.

The air interface synchronization signaling may include at least one of: a layer number of the cell, cluster information of a cell cluster in which the cell is located, a position and period information of a sub-frame of a cell in each layer and this cell for monitoring air interface synchronization, a level of a timing difference between the cell and a macro cell, configuration information of a sub-frame of an MBSFN of the cell, off information of the cell, time-division duplex upward/downward (D/U) configuration information of the cell, configuration information of a reference signal (RS) of air interface synchronization, and on information of the cell.

The air interface synchronization signaling may be sent through a dedicated radio resource control (RRC) message or a system information block (SIB) of a system broadcast message, or a dedicated broadcast.

When an air interface synchronization signaling is included only in the system information block, the SIB may be scheduled to be sent in a sub-frame for monitoring air interface synchronization.

When the system information block is sent, a control signaling may be sent in a physical downlink control channel (PDCCH) an enhanced PDCCH (ePDCCH) and is scrambled using an agreed radio network temporary identification (RNTI), and the system information block is scheduled and sent in the a physical downlink shared channel (PDSCH) according to the control signaling.

The method may further include: whether the air interface synchronization signaling is updated that is indicated through the PDCCH or ePDCCH.

When the air interface synchronization signaling is sent using a dedicated RRC message, sending time may be satisfied: the air interface synchronization signaling is sent for a first time, or an air interface synchronization signaling is updated.

The indicating may be implemented, in the PDCCH or ePDCCH, through adding a parameter into downlink control information (DCI) of a control signaling corresponding to the air interface synchronization signaling, or using an existing parameter of the DCI.

The off information of the cell may refer to time information when the cell is switched to be off.

When the air interface synchronization signaling is transmitted in the monitoring sub-frame, the air interface synchronization signaling may be transmitted using an orthogonal frequency division multiplexing (OFDM) symbol excepting for a first or first two OFDM symbols in the monitoring sub-frame.

The method further includes:

when the cell performs an RRC connection establishment for an access device, the cell may use a dedicated RRC message to send an air interface synchronization signaling to the small cell for a first time, wherein a sub-frame sent this time comprises a sub-frame for monitoring none air interface synchronization.

It is provided a method for processing an air interface synchronization signaling, the method includes:

a small cell obtains a position of a sub-frame for monitoring air interface synchronization and receiving an air interface synchronization signaling in a monitoring sub-frame.

The method may further include:

when an air interface synchronization signaling is sent through a dedicated radio resource control (RRC) message, using a configured radio network temporary identification (RNTI) to retrieve a control signaling of the dedicated RRC message in a physical downlink control channel (PDCCH)/an enhanced PDCCH (ePDCCH) of a sub-frame for monitoring air interface synchronization, and receiving the air interface synchronization signaling from a physical downlink shared channel (PDSCH) according to the control signaling.

The method may further include:

the small cell monitors an air interface synchronization signaling in each monitoring sub-frame, and considers that the air interface synchronization signaling is not updated when no air interface synchronization signaling belonging to the small cell is found.

The method may further include:

the small cell receives a reference signal from the sub-frame for monitoring air interface synchronization so as to perform an air interface synchronization process.

The method may further include:

the small cell receives an air interface synchronization signaling from the PDSCH according to a control signaling, when the small cell receives downlink control information (DCI) of a control signaling of the air interface synchronization signaling and the small cell determines that the air interface synchronization signaling is updated based on the DCI.

The method may further include:

the small cell sends a notification that a type of an access device is a small cell, when the small cell establish an RRC connection.

The method may further include:

the small cell receives an air interface synchronization signaling sent for the first time through a dedicated RRC message, after establishing the RRC connection.

It is provided a device for processing an air interface synchronization signaling, the device is a base station or a base station controller of a cell, the device comprising:

a first obtaining unit, configured to obtain a position of a sub-frame for monitoring air interface synchronization; and

a sending unit, configured to send an air interface synchronization signaling of the cell at the position of the sub-frame, wherein the sub-frame for monitoring air interface synchronization is a sub-frame of the cell, and other cells receive a reference signal for air interface synchronization of the cell in the sub-frame.

The sending unit may be further configured to send the air interface synchronization signaling through a dedicated radio resource control (RRC) message or a system information block (SIB) of a system broadcast message or a dedicated broadcast.

The sending unit may be further configured to schedule and send the system information block only in a sub-frame for monitoring air interface synchronization when an air interface synchronization signaling is included in the system information block.

The sending unit may be further configured to send a control signaling in a physical downlink control channel (PDCCH)/an enhanced PDCCH (ePDCCH) and scramble the control signaling with an agreed radio network temporary identification (RNTI), and schedule and send the system information block in a physical downlink shared channel (PDSCH) according to the control signaling, when sending the system information block.

The sending unit may be further configured to indicate whether the air interface synchronization signaling is updated through the PDCCH or ePDCCH.

The sending unit may be further configured to implement the indicating through adding a parameter into downlink control information (DCI) of a control signaling corresponding to the air interface synchronization signaling in the PDCCH or ePDCCH, or using an existing parameter of the DCI.

The sending unit may be further configured to use an orthogonal frequency division multiplexing (OFDM) symbol excepting for a first or first two OFDM symbols in the monitoring sub-frame to transmit the air interface synchronization signaling.

The sending unit may be further configured to: use a dedicated RRC message to send an air interface synchronization signaling to the small cell for a first time, when an RRC connection establishment is performed for an access device, wherein a sub-frame sent this time comprises a sub-frame for monitoring none air interface synchronization.

It is provided a device for processing an air interface synchronization signaling, the device is a base station or a base station controller of a small cell and the device:

a second obtaining unit, configured to obtain a position of a sub-frame for monitoring air interface synchronization; and

a receiving unit, configured to receive an air interface synchronization signaling from a monitoring sub-frame.

The receiving unit may be further configured to: use a configured radio network temporary identification (RNTI) to retrieve a control signaling of the dedicated RRC message in a physical downlink control channel (PDCCH)/an enhanced PDCCH (ePDCCH) of a sub-frame for monitoring air interface synchronization, and receive the air interface synchronization signaling from a physical downlink shared channel (PDSCH) according to the control signaling, when an air interface synchronization signaling is received through a dedicated RRC message.

The second obtaining unit may be configured to: monitor an air interface synchronization signaling in each monitoring sub-frame, and consider that the air interface synchronization signaling of the source cell is not updated, when its air interface synchronization signaling is not found.

The receiving unit may be further configured to receive a reference signal in a sub-frame for monitoring air interface synchronization so as to perform an air interface synchronization process.

The receiving unit may be further configured to: receive an air interface synchronization signaling from a PDSCH according to a control signaling, when receiving downlink control information (DCI) of a control signaling of the air interface synchronization signaling and determining that the air interface synchronization signaling is updated based on the DCI.

The receiving unit may be further configured to: send a notification that a type of an access device is a small cell, when establishing an RRC connection.

The receiving unit may be further configured to: receive an air interface synchronization signaling sent for a first time through a dedicated RRC message after establishing the RRC connection.

It is provided a method for processing an air interface synchronization signaling, including,

a small cell launches and performs a random accessing process for a source cell, reporting, by the small cell, a reason why its requesting connection is established during the random accessing process; and sends, by the source cell, an initial air interface synchronization signaling for the small cell according to an agreed reason, after a radio resource control (RRC) connection is established successfully, where the reason for requesting connection establishment is implemented by reporting its type of the small cell.

The embodiments of the present disclosure provides a computer storage medium storing computer executable instructions thereon for performing methods for processing any one air interface synchronization signaling described above.

In a technology for processing an air interface synchronization signaling of the present disclosure, an air interface synchronization signaling is sent in a sub-frame for monitoring configured by the cell, thereby facilitating receiving the air interface synchronization signaling by other small cells, and preventing other small cells from stopping sending information to a subordinate UE in order to receive an updated air interface synchronization signaling, thus the other small cells may receive an air interface synchronization signaling (or an updated air interface synchronization signaling) while monitoring.

### BRIEF DESCRIPTION OF THE DRAWINGS

FIG. 1 is a simplified flow chart for processing an air interface synchronization signaling according to an embodiment of the present disclosure;

FIG. 2 is a first schematic structural diagram of a device for processing an air interface synchronization signaling according to the present disclosure; and

FIG. 3 is a second schematic structural diagram of a device for processing an air interface synchronization signaling according to the present disclosure.

### DETAILED DESCRIPTION

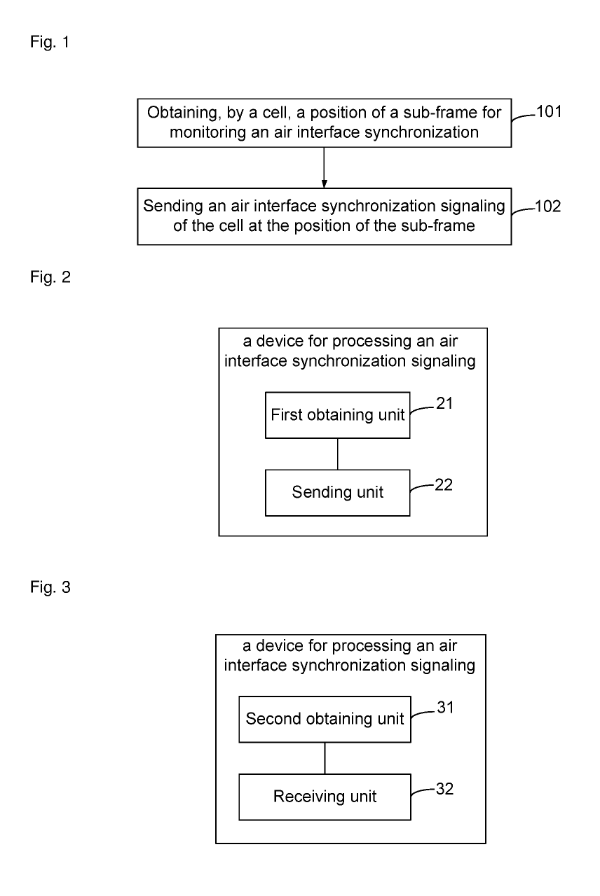

In general, as shown in FIG. 1, in step 101, a cell (including a macro cell and a small cell) may obtain a position of a sub-frame for monitoring an air interface synchronization; in step 102, an air interface synchronization signaling of the cell is sent at the position of the sub-frame, that is, the air interface synchronization signaling of the cell is sent only in the sub-frame of the cell for monitoring air interface synchronization; wherein, the sub-frame for monitoring the air interface synchronization is a sub-frame of the cell, other cells receive a reference signal for an air interface synchronization send by the cell in the sub-frame.

The air interface synchronization signaling includes at least one of: a layer number of the cell, cluster information of a cell cluster in which the cell is located, a position and period information of a sub-frame of a cell in each layer and this cell for monitoring air interface synchronization, a level of a timing difference between the cell and a macro cell, configuration information of a sub-frame of an MBSFN of the cell, stopping/power off/switch off/off information of the cell, time-division duplex (TDD) upward/downward (D/U) configuration information of the cell, configuration information of a reference signal (RS) of air interface synchronization, and starting/power on/switch on/on information of the cell.

The air interface synchronization signaling is sent via a dedicated radio resource control (RRC) message or a system information block (SIB) in a system broadcast message, or a dedicated broadcast for the small cell.

When an air interface synchronization signaling is included in the system information block, the system information block is scheduled to be sent in a sub-frame for monitoring air interface synchronization.

When information of the system information block is updated, a cell re-receives the system information block and obtains a new air interface synchronization signaling.

When information of the system information block is updated, a parameter, systemInfoModification, for indicating system broadcast message update in a paging message is not indicated.
whether the air interface synchronization signaling is updated that is indicated through a PDCCH or an ePDCCH.

When an air interface synchronization signaling is sent through a system information block, the system information block is not scheduled through an SIB 1, but directly sent in a sub-frame for monitoring air interface synchronization, specifically, a control signaling is sent in a PDCCH/an ePDCCH and is scrambled using an agreed radio network temporary identification (RNTI), and is scheduled in a PDSCH according to the control signaling and sent to the system information block.

When an air interface synchronization signaling is sent through a dedicated RRC message, a small cell for receiving the air interface synchronization signaling uses a configured RNTI (may be a C-RNTI) to retrieve a control signaling of the dedicated RRC in a PDCCH/an ePDCCH of a sub-frame for monitoring an air interface synchronization, and receives air interface synchronization from the PHSCH according to the control signaling.

In case that an air interface synchronization signaling is sent using a dedicated RRC message, a cell sending a dedicated RRC information sends an air interface synchronization signaling to a certain small, when: an air interface synchronization signaling is sent to the small cell for the first time, or an air interface synchronization signaling is updated.

A small cell, for receiving an air interface synchronization signaling of a source cell, monitors an air interface synchronization signaling in a sub-frame of the source cell for monitoring an air interface synchronization signaling, and considers that the air interface synchronization signaling of the source cell is not updated, if no air interface synchronization signaling belonged to the small cell is found.

In case that an air interface synchronization signaling is sent using a dedicated RRC message, a cell sending a dedicated RRC information sends an air interface synchronization signaling to a certain small, when: an air interface synchronization signaling is sent to the small cell for the first time, or an air interface synchronization signaling is updated.

The source cell sends an air interface synchronization signaling only in each sub-frame for monitoring air interface synchronization by using a dedicated broadcast manner with respect to a small cell.

The small cell receives a reference signal from the sub-frame for monitoring air interface synchronization so as to perform an air interface synchronization process, while receiving an air interface synchronization signaling from the monitoring sub-frame.

An update indication is sent in a PDCCH or an ePDCCH, for indicating that whether the air interface synchronization signaling is updated compared to an air interface synchronization signaling which is sent the last time.

The update indication is implemented in a following manner: adding a parameter to a downlink control information (DCI) of a control signaling corresponding to the air interface synchronization signaling in a PDCCH or an ePDCCH, or using an existing parameter of the DCI.

Upon reception of DCI of a control signaling of an air interface synchronization signaling sent by the source cell, if the small cell acknowledges that the air interface synchronization signaling is updated based on the DCI, the small cell receives the air interface synchronization signaling from a PDSCH according to the control signaling.

The off information of the cell refers to time information when the cell is switched to be off.

With respect to the monitoring sub-frame, the ePDCCH uses an orthogonal frequency division multiplexing (OFDM) symbol excepting for the first or the first two OFDM symbols, and a physical resource block (PRB) resource is previously agreed.

The air interface synchronization signaling is transmitted in the monitoring sub-frame, specifically, the air interface synchronization signaling is transmitted using an OFDM symbol excepting for the first or the first two OFDM symbols in the monitoring sub-frame.

When the cell performs an RRC connection establishment for an access device, and acknowledges that the access device is a small cell, the cell uses a dedicated RRC message to send an air interface synchronization signaling to the small cell for the first time, where a sub-frame sent this time includes a sub-frame for monitoring none air interface synchronization.

When the monitoring small cell establishes an RRC connection with the cell, the monitoring small cell notifies the cell that the type of the access device is a small cell. After the RRC connection is established, the monitoring small cell receives an air interface synchronization signaling sent by the cell for the first time using a dedicated RRC message, where a sub-frame received this time includes a sub-frame for monitoring none air interface synchronization.

The present disclosure is explained in detail below in conjunction with embodiments.

In a practical application, a sending mechanism is provided for facilitating a source cell sending an air interface synchronization signaling for monitoring, such that the cell may obtain a position of a sub-frame for monitoring air interface synchronization, and sends an air interface synchronization signaling of the cell at the position of the sub-frame. Specifically, the sub-frame for monitoring air interface synchronization is a sub-frame of the cell, and other cells can receive a reference signal for air interface synchronization in the sub-frame sent by the cell. Specifically, the cell may obtain a position of a sub-frame for monitoring air interface synchronization, where the position may be a position of a sub-frame for air interface synchronization which is configured by the cell autonomously or by the cell in an OAM manner, or may also be a position of a sub-frame for air interface synchronization which is configured by a receiving master control node of the cell. The position of the sub-frame may be a special sub-frame number, or include a sub-frame number and period information.

When an air interface synchronization signaling for monitoring which is configured in a source cell is updated, the source cell needs to send the air interface synchronization signaling in a sub-frame configured to monitor an air interface synchronization.

The monitoring small cell receives the air interface synchronization signaling in the sub-frame for monitoring air interface synchronization which is configured by the source cell, while receiving a reference signal for air interface synchronization.

The air interface synchronization signaling is sent using the sub-frame for monitoring air interface synchronization, such that: the monitoring small cell can receive an air interface synchronization signaling during performing a monitoring process (receiving a reference signal of the source cell), thus, the monitoring small cell does not need to stop sending a signal for a subordinate UE when receiving an air interface synchronization signaling, thereby facilitating the operation of the subordinate UE of the monitoring small cell. If an air interface synchronization signaling is not sent in the sub-frame for monitoring air interface synchronization, the monitoring small cell needs to stop sending a signal for a subordinate UE when receiving an air interface synchronization signaling, thereby affecting measurement of the UE.

Specifically, the air interface synchronization signaling includes one or more of: a layer number of the cell (i.e., the source cell), the definition of which is referred to a part of the background; cluster information of a cell cluster in which the cell is located, for example, a cluster ID information of a cell cluster in which the cell is located; a position and period information of a sub-frame of a cell in each layer and this cell for monitoring an air interface synchronization; a level of a timing difference between the cell and a macro cell, specifically, timing difference information between the cell and an adjacent macro cell; configuration information of a sub-frame of an MBSFN of the cell, which refers to a sub-frame configuration of an MBSFN of the cell; off information of the cell, i.e., time information when the cell is switched to be off, when the source cell performs an off operation, the source cell needs to send the time information when the cell is switched to be off to the monitoring small cell, as such, the monitoring small cell can reselect a source cell belong to the monitoring small cell in time; time-division duplex upward/downward (D/U) configuration information of the cell, i.e., if the cell is in TDD mode, the D/U configuration information of the cell should be sent, especially, when the cell has an enhanced interference management and transmission adaption (eIMTA) ability, the cell is allowed to change the D/U configuration information of the cell through a dynamic of the DCI; configuration information of a reference signal (RS) of an air interface synchronization, which refers to the type of the RS for an air interface synchronization sent by the cell, further, which may include a pattern of the RS, for example, the RS for an air interface synchronization of the cell is a CRS, or a channel state indication reference signal (CSI-RS), or a positing reference signal (PRS).

On information of the cell refers to time information when the cell is switched to be on, from which the monitoring small cell can obtain which cells surrounding the small monitoring cell have been restarted, such that the monitoring small cell has a chance to adjust a source cell belong to the monitoring small cell. State information of the source cell refers to a manner in which the cell is synchronized when the cell is a source cell, for example, a GPS manner or an air interface synchronization manner to implement a synchronization process. The above information needs to be notified to the monitoring small cell, thereby facilitating performing air interface synchronization by the monitoring small cell.

Typically, a certain relationship is existed between a hop and a layer number, for example, a maximum layer number of a configuration system is 3 (a synchronized source cell most original is 0 layer), a maximum hop of a corresponding system is 3 hops. In the present disclosure, a maximum layer number supported by a system (for example, a macro cell and a subordinate small cell thereof) is required to be sent (sending to a small cell), the maximum layer number supported by the system can be configured according to a specific deployment scenario of the small cell. Since a corresponding relationship is existed between a layer number and a hop, a description related to the layer number is adapted to the hop, the present disclosure is described taken a layer number as an example.

When an air interface synchronization signaling is sent in a sub-frame, the air interface synchronization signaling can be sent in a dedicated RRC message manner or using a system information block of a system broadcast message, or using a dedicated broadcast with respect to the small cell. The above three manners will be described in detail below.

For a first manner, an air interface synchronization signaling is sent using a system information block. A source cell schedules a system information block including an air interface synchronization signaling only in a sub-frame for monitoring itself air interface synchronization. The system information block does not configure and schedule information through an SIB1, and is always sent in a sub-frame for monitoring air interface synchronization, and it is not necessary to configure an update indication in a paging message if information of the system information block is updated, that is, a parameter system InfoModification for indicating that the system broadcast message is updated in the paging message is not indicated, when the information of the system information block is updated. The monitoring small cell receives the system information block in each sub-frame for monitoring air interface synchronization of the source cell so as to obtain an air interface synchronization signaling of the system information block. In the present disclosure, whether information of the system information block is updated that is included through a PDCCH or an ePDCCH. Specifically, a step that the system information block is sent in a sub-frame for monitoring air interface synchronization can be implemented in a following manner: sending a control signaling of the system information block in the PDCCH or ePDCCH or scrambling the control signaling with an agreed RNTI, and scheduling the system information block in the PDSCH according to the control signaling and sending the system information block. When the control signaling of the system information block is sent through the PDCCH, when the monitoring small cell receives an air interface synchronization signaling of the source cell, the monitoring small cell needs to configure itself sub-frame to be an MBSFN sub-frame, and further receive symbols of all the OFDM of a monitoring sub-frame of the source cell, where the monitoring small cell cannot send signal to a subordinate UE at the first one or first two symbols of the OFDM of the MBSFN sub-frame itself. When the control signaling of the system information block is sent through the ePDCCH, resources occupied by the ePDCCH should be agreed previously, such that the monitoring small cell can obtain dedicated resources sent by the ePDCCH (for example, resources for a control channel element (CCE)) according to the agreed resources so as to receive accurately ePDCCH

symbols of an OFDM of the monitoring sub-frame for monitoring excepting for the first one or first two symbols of the OFDM, and it is necessary to avoid using the first one or first two symbols of the OFDM in the monitoring sub-frame when the system information block is sent in the PDSCH. For example, an initial symbol of the OFDM and a PRB sent by through ePDCCH in the sub-frame for monitoring air interface synchronization are agreed. Further, a resource element group (REG) and a resource element (RE) sent by through ePDCCH in the sub-frame for monitoring air interface synchronization are ag reed.

The control signaling of the system information block is sent in the PDCCH or ePDCCH and is scrambled with an agreed RNTI, the system information block is scheduled from the PDSCH according to the control signaling and is sent.

For a second manner, an air interface synchronization signaling is sent using a dedicated RRC message, C-RNTI is configured for a small cell for receiving an air interface synchronization signaling, a monitoring small cell retrieves a control signaling of itself RRC message from PDCCH or ePDCCH of a sub-frame for monitoring air interface synchronization, and receive an air interface synchronization signaling form the PDSCH according to the control signaling. A source cell sends a dedicated RRC message of the air interface synchronization signaling to the monitoring small cell only when the monitoring small cell performs air interface synchronization or an air interface synchronization signaling of the source cell is updated. When an air interface synchronization signaling is sent through the dedicated RRC message, it is necessary for the source cell to acknowledge which small cells consider this source cell as a source cell, thus the source cell can accurately send a dedicated RRC message to a small cell corresponding to the source cell. When an air interface synchronization signaling is sent through the dedicated RRC message, the monitoring small cell needs to monitor the PDCCH or ePDCCH in each sub-frame for monitoring of the source cell so as to obtain the air interface synchronization signaling, and if the monitoring small cell finds no air interface synchronization signaling belongs to the monitoring small cell, the monitoring small cell considers that an air interface synchronization signaling of the source cell is not updated, and continues to use the previous air interface synchronization signaling. The limitation of the PDCCH or ePDCCH or the PDSCH for transmitting an air interface synchronization signaling in the first manner is also adapted to the second manner.

For a third manner, when an air interface synchronization signaling is sent in a dedicated broadcast manner for a small cell, it is necessary to set common agreed RNTI with respect to the dedicated broadcast manner for the small cell, and use the RNTI to scramble a control signaling of an air interface synchronization signaling sent through a PDCCH or an ePDCCH, where the control signal is used to control the air interface synchronization signaling to be transmitted in the PDSCH. The source cell sends an air interface synchronization signaling in a dedicated broadcast manner for a small cell only in each sub-frame for monitoring air interface synchronization. The monitoring small cell receive a synchronized reference signal from a sub-frame for monitoring air interface synchronization, and receive an air interface synchronized signaling from the monitoring sub-frame. The monitoring small cell obtains an air interface synchronization signaling at each time so as to protect the signaling from being updated. Similarly, when the source cell sends an air interface synchronization signaling through PDCCH or ePDCCH or PDSCH, the limitation in the first manner is also adapted to the third manner. Whether an air interface synchronization signaling sent in a dedicated broadcast manner for the small cell is updated that may be also indicated through the PDCCH or ePDCCH.

In the step that whether an air interface synchronization signaling is updated that is indicated through the PDCCH or ePDCCH, specifically, the step is implemented in a following way: adding a parameter in DCI of a control signaling corresponding to an air interface synchronization signaling, or using an existing parameter of the DCI. For example, a used state of an existing parameter of the DCI is used to indicate it. After the small cell receives the DCI of the control signaling of the air interface synchronization signaling sent by the source cell, if the small cell acknowledges that the air interface synchronization signaling is updated from the DCI, the small cell can receive the air interface synchronization signaling from the PDSCH according to the control signaling, if not, the air interface synchronization signaling received from the PDSCH is not analyzed and the previous air interface synchronization signaling is still used.

The second manner further includes: when deployed initially, the monitoring small cell acts as a UE for accessing a cell and establishes an RRC connection with the cell. During establishing of the RRC connection, the monitoring small cell needs to report the reason of requirement for establishing the RRC connection, from this reason, the cell to be accessed is notified that the type of the monitoring small cell is a small cell, and the purpose for accessing is to obtain air interface synchronization with the cell; or during establishing of the RRC connection, when the monitoring small cell notifies that itself type is a small cell, and agrees that a default type of a cell to be accessed is a small cell, it is necessary to send a configured air interface synchronization signaling to the monitoring small cell through a dedicated RRC message.

A process for accessing a cell of the monitoring small cell is similar to an existing process for accessing a cell of a UE, the difference between them is in that: during accessing to a cell, the monitoring small cell needs to notify directly or indirectly the cell that itself type is a small cell, such that the cell is triggered to send an air interface synchronization signaling to the monitoring small cell through a dedicated RRC message. At this time, the air interface synchronization signaling is sent to the small cell by the cell through the dedicated RRC message for the first time, thus the air interface synchronization signaling is not defined to be sent in a sub-frame for monitoring air interface synchronization, because the monitoring small cell has no subordinate UE at this time. However, from then, the monitoring small cell is operated normally and has a subordinate UE, and the monitoring small cell can receive an air interface synchronization signaling only in a sub-frame for monitoring air interface synchronization of the source cell through a dedicated RRC message. The source cell not only sends the air interface synchronization signaling to the monitoring small cell through a dedicated RRC message for the first time, but also sends the air interface synchronization signaling in a monitoring sub-frame through a dedicated RRC message.

During accessing a cell of a monitoring small cell (a process for establishing an RRC connection), the cell configures a C-RNTI for the monitoring small cell, this C-RNTI is always used by the monitoring small cell in each monitoring sub-frame such that an air interface synchronization signaling is received. The source cell also always uses this C-RNTI to send an air interface synchronization signaling for the monitoring small cell, a C-RNTI is re-obtained unless the monitoring small cell re-performs an RRC connection. The monitoring small cell is always considered as a UE in an RRC connection state, unless the monitoring small cell is off.

For the third manner, when an initial accessing process is implemented, the difference between the third manner and the second matter is in that: in the third manner, the C-RNTI is no longer be used after an air interface synchronization signaling is received by the monitoring small cell, both the source cell and the monitoring small cell consider the monitoring small cell as a UE in an RRC idle state, and a C-RNTI allocated to the monitoring small cell can be utilized again. After receiving an air interface synchronization signaling for the first time, the monitoring small cell can obtain a position and period of the monitoring sub-frame, and then receive an air interface synchronization signaling in a monitoring sub-frame of the source cell through a dedicated broadcast for the small cell.

With respect to the above condition, in order to reduce the overhead when the monitoring small cell or the source cell sends the air interface synchronization signaling through the RRC message, it is recommended that: after an RRC connection is established between the monitoring small cell and the source cell (an uplink random accessing is launched successfully), the source cell only sends a position and/or period information of a sub-frame for monitoring air interface synchronization to the monitoring small cell to which the RRC connection is established, other air interface synchronization signaling may be not sent this time.

Further, when a connection between the small cell and the source call is established, the small cell may be considered as a UE, the small cell launches and performs a random accessing process for the source cell. During the random accessing process, the small cell reports the reason why itself requesting connection is established; and after an RRC connection is established successfully, the source cell sends an initial air interface synchronization signaling for the small cell according to an agreed reason. The reason for requesting connection establishment can be implemented by reporting its type of the small cell.

Specific implementations of the present disclosure are explained below by means of embodiments.

### First Embodiment

When a small cell is deployed, the small cell is considered as an UE and performs a cell search process, so as to find a cell. Specifically, the small cell searches all cells of a specified frequency band, and selects a most suitable cell to access it and completes an RRC connection establishment.

During the RRC connection establishment, the small cell reports itself type is a small cell.

The cell may acknowledges that the object for this RRC connection establishment is a small cell, therefore, the cell may send an air interface synchronization signaling to the small cell through a dedicated RRC message for the first time after the RRC connection establishment is completed.

The small cell receives the air interface synchronization signaling and analyses a position or period information of a sub-frame of the cell for monitoring air interface synchronization, and thus determines a sub-frame for monitoring air interface synchronization.

The cell uses a C-RNTI of the small cell to send an air interface synchronization signaling in each sub-frame for monitoring air interface synchronization.

The small cell uses the C-RNTI to receive an air interface synchronization signaling belongs to itself in each sub-frame of the source cell for monitoring air interface synchronization.

### Second Embodiment

When a small cell is deployed, the small cell is considered as an UE and performs a cell search process, so as to find a cell. Specifically, the small cell searches all cells of a specified frequency band, and selects a most suitable cell to access it and completes an RRC connection establishment.

During the RRC connection establishment, the small cell reports itself type is a small cell.

The cell may acknowledges that the object for this RRC connection establishment is a small cell, therefore, the cell may send an air interface synchronization signaling to the small cell through a dedicated RRC message for the first time after the RRC connection establishment is completed.

The small cell receives the air interface synchronization signaling and analyses a position or period information of a sub-frame of the cell for monitoring air interface synchronization, and thus determines a sub-frame for monitoring air interface synchronization.

The cell determines whether the air interface synchronization signaling has been updated, if the air interface synchronization signaling has been updated, the air interface synchronization signaling is sent using a C-RNTI of the small cell in the next sub-frame for monitoring air interface synchronization (may also, the cell sends a updated air interface synchronization signaling to the monitoring small cell using the dedicated RRC message in the next sub-frame of the cell for monitoring air interface synchronization), and if not, the air interface synchronization signaling is not sent.

The small cell uses the C-RNTI to receive an air interface synchronization signaling belongs to itself in each sub-frame of the source cell for monitoring air interface synchronization.

### Third Embodiment

When a small cell is deployed, the small cell is considered as an UE and performs a cell search process, so as to find a cell. Specifically, the small cell searches all cells of a specified frequency band, and selects a most suitable cell to access it and completes an RRC connection establishment.

During the RRC connection establishment, the small cell reports itself type is a small cell.

The cell may acknowledges that the object for this RRC connection establishment is a small cell, therefore, the cell may send an air interface synchronization signaling to the small cell through a dedicated RRC message for the first time after the RRC connection establishment is completed.

The small cell receives the air interface synchronization signaling and analyses a position or period information of a sub-frame of the cell for monitoring air interface synchronization, and thus determines a sub-frame for monitoring air interface synchronization.

The cell sends an air interface synchronization signaling using a common agreed RNTI in each sub-frame for monitoring air interface synchronization.

The small cell uses the C-RNTI to receive an air interface synchronization signaling belongs to the small cell itself using the common agreed RNTI in each sub-frame of the source cell for monitoring air interface synchronization.

### Fourth Embodiment

When a small cell is deployed, the small cell is considered as an UE and performs a cell search process, so as to find a cell. Specifically, the small cell searches all cells of a specified frequency band, and selects a most suitable cell to access it and completes an RRC connection establishment.

During the RRC connection establishment, the small cell reports itself type is a small cell.

The cell may acknowledges that the object for this RRC connection establishment is a small cell, therefore, the cell may send an air interface synchronization signaling to the small cell through a dedicated RRC message for the first time after the RRC connection establishment is completed.

The small cell receives the air interface synchronization signaling and analyses a position or period information of a sub-frame of the cell for monitoring air interface synchronization, and thus determines a sub-frame for monitoring air interface synchronization.

The cell determines whether the air interface synchronization signaling has been updated, if the air interface synchronization signaling has been updated, the air interface synchronization signaling is sent using a common agreed C-RNTI of the small cell in the next sub-frame for monitoring air interface synchronization (may also, the cell sends an updated air interface synchronization signaling to the monitoring small cell using a dedicated RRC message for the small cell in the next sub-frame for monitoring air interface synchronization, rather than a sub-frame of the cell for non-air interface synchronization), and if not, the air interface synchronization signaling is not sent.

The small cell uses the C-RNTI to receive an air interface synchronization signaling belongs to itself in each sub-frame of the source cell for monitoring air interface synchronization.

The small cell attempts to receive an air interface signaling belongs to the small cell using common agreed RNTI in each sub-frame of the source cell for monitoring air interface synchronization. If an air interface synchronization signaling is received, the received air interface synchronization signaling is used, or else, the previous air interface synchronization signaling is still used.

### Fifth Embodiment

An initial synchronization and signaling interaction process of a small cell is described as follows.

When a small cell is deployed, the small cell is considered as an UE and performs a cell search process, so as to find a cell. Specifically, the small cell searches all cells of a specified frequency band, and selects a most suitable cell to access it and completes an RRC connection establishment.

During the RRC connection establishment, the small cell reports itself type is a small cell.

The cell may acknowledges that the object for this RRC connection establishment is a small cell, therefore, the cell may send an air interface synchronization signaling to the small cell through a dedicated RRC message for the first time after the RRC connection establishment is completed. A control signaling of the air interface synchronization signaling which is transmitted in the PDSCH, is scrambled with C-RNTI allocated to the small cell and is sent through a PDCCH or an ePDCCH.

The small cell receives the air interface synchronization signaling, and analyses the air interface synchronization signaling of the cell.

### Sixth Embodiment

An initial synchronization and signaling interaction process of a small cell is described as follows.

When a small cell is deployed, the small cell is considered as an UE and performs a cell search process, so as to find a cell. Specifically, the small cell searches all cells of a specified frequency band, and selects a most suitable cell to access it and completes an RRC connection establishment.

During the RRC connection establishment, the small cell reports itself type is a small cell.

If acknowledging that the object of the RRC connection establishment is a small cell, the cell sends an air interface synchronization signaling to the accessed small cell for the first time with respect to a dedicated broadcast of the small cell after the RRC connection is established.

A control signaling of the air interface synchronization signaling which is transmitted in the PDSCH, is scrambled with common C-RNTI agreed by the small cell and is sent through PDCCH or ePDCCH.

The small cell receives the air interface synchronization signaling, and analyses the air interface synchronization signaling of the cell.

It is should be noted that, for convenience of description, when an operation subject in the above description relates to a cell or a small cell, the description is illustrated directly that a respective cell or small cell performs a respective operation. In a practical application, specific operation subject may often be a communication control device in a respective cell or small cell, such as a base station or a base station controller or the like.

It can be seen from the above description, with respect to either the method or the device, in a technology for processing an air interface synchronization signaling of the present disclosure, an air interface synchronization signaling is sent in a sub-frame for monitoring configured by the cell, thereby facilitating receiving the air interface synchronization signaling by other small cells, and preventing other small cells from stopping sending information to a subordinate UE in order to receive an updated air interface synchronization signaling, thus the other small cells may receive an air interface synchronization signaling (or an updated air interface synchronization signaling) while performing a monitoring process.

The embodiments of the present disclosure further provide a computer storage medium storing computer executable instructions thereon for performing a method for processing an air interface synchronization signaling described above.

The embodiments of the present disclosure further provides a device for processing an air interface synchronization signaling, and the device is a base station or a base station controller, as shown in FIG. 2, the device includes:

a second obtaining unit 21, which is configured to obtain a position of a sub-frame for monitoring air interface synchronization; and

a sending unit 22, which is configured to send an air interface synchronization signaling of the cell at the position of the sub-frame, where the sub-frame for monitoring air interface synchronization is a sub-frame of the cell, and other cells receive a reference signal for air interface synchronization of the cell in the sub-frame.

In an embodiment, the sending unit 22 is further configured to send the air interface synchronization signaling through an RRC message or a system information block of a system broadcast message or a dedicated broadcast.

In an embodiment, the sending unit 22 is further configured to schedule a system information block and send the system information block only in the sub-frame for monitoring air interface synchronization when an air interface synchronization signaling is included in the system information block.

In an embodiment, the sending unit 22 is further configured to: when sending the system information block, send a control signaling in a PDCCH/an ePDCCH and scramble the control signaling with an agreed RNTI, and schedule and send the system information block in a PDSCH according to the control signaling.

In an embodiment, the sending unit 22 is further configured to indicate that whether the air interface synchronization signaling has been updated through the PDCCH or ePDCCH.

In an embodiment, the sending unit 22 is further configured to implement the indication through adding a parameter in DCI of the control signaling corresponding to the air interface synchronization signaling in a PDCCH or an ePDCCH, or using an existing parameter of the DCI.

In an embodiment, the sending unit 22 is further configured to use an orthogonal frequency division multiplexing (OFDM) symbol excepting for the first or the first two OFDM symbols in the monitoring sub-frame to transmit the air interface synchronization signaling.

In an embodiment, the sending unit 22 is further configured to: use a dedicated RRC message to send an air interface synchronization signaling to the small cell for the first time, when an RRC connection establishment is performed for an access device, where a sub-frame sent this time includes a sub-frame for monitoring none air interface synchronization.

In a practice application, the first obtaining unit 21 may be implemented by a processor or a logic programmable gate array (FPGA); and the sending unit 22 may be implemented by a transmitter of the device.

A device for processing an air interface synchronization signaling is provided according to embodiments of the present disclosure, and the device may be a base station or a base station controller of a small cell, as shown in FIG. 3, the device includes:

a second obtaining unit 31, which is configured to obtain a position of a sub-frame for monitoring an air interface synchronization; and

a receiving unit 32, which is configured to receive an air interface synchronization signaling from a monitoring sub-frame.

where, the receiving unit 32 is further configured to: use a configured RNTI to retrieve a control signaling of the dedicated RRC in a PDCCH/an ePDCCH of a sub-frame for monitoring an air interface synchronization, and receive the air interface synchronization from the PHCCH according to the control signaling, when an air interface synchronization signaling is received through a dedicated RRC message.

In an embodiment, the second obtaining unit 31 is further configured to: monitor an air interface synchronization signaling in a sub-frame of the source cell for monitoring an air interface synchronization signaling, and consider that the air interface synchronization signaling of the source cell is not updated, if no air interface synchronization signaling belonging to the small cell is found.

In an embodiment, the receiving unit 32 is further configured to receive a reference signal in a sub-frame for monitoring air interface synchronization so as to perform an air interface synchronization process.

In an embodiment, the receiving unit 32 is further configured to: when receiving DCI of a control signaling of the air interface synchronization signaling and acknowledging that the air interface synchronization signaling has been updated based on the DCI, receive an air interface synchronization signaling from the PDSCH according to the control signaling.

In an embodiment, the receiving unit 32 is further configured to: send a notice that the type of an access device is a small cell, when establishing an RRC connection.

In an embodiment, the receiving unit 32 is further configured to: receive an air interface synchronization signaling sent for the first time through an RRC message after establishing an RRC connection.

In a practical application, the second obtainingunit 31 may be implemented by a [symbol] ; processor or a logic programmable gate array of a device, and the receiving unit 32 may be implemented by a receiver of the device.

It should be understood by those skilled in the art that embodiments of the present disclosure may provide a method, a system, or a computer program product. Accordingly, the present disclosure can take the form of hardware embodiments, software embodiments, or a combination of forms of embodiment of software and hardware aspects. Furthermore, the present disclosure may take the form of a computer program product which is embodied on one or more computer-usable storage media (including, but not limited to, a disk storage, optical storage, and the like) having computer-usable program code embodied therein.

The present disclosure is described in accordance with a method, a device (system), and flow charts and/or block diagrams of a program product according to embodiments of the present disclosure. It should be understood that each process and/or block in the flowcharts and/or block diagrams, and a combination of flows and blocks in the flowcharts and/or block diagrams are implemented by the computer program instructions. These computer program instructions may be provided to a processor of a general purpose computer, a dedicated purpose computer, an embedded processor or other programmable data processing apparatus to produce a machine, such that a device for implementing the functions specified in a flow or flows of flowcharts or a block or blocks of block diagrams is produced through the instructions which are executed through the processor of the computer or other programmable data processing device.

These computer program instructions may also be stored in a computer readable memory that can direct a computer or other programmable data processing apparatus to be operated in a particular manner, such that the instructions stored in the computer readable memory produce an article of manufacture including instruction means which implement the function in a flow or flows of flowcharts or a block or blocks of block diagrams.

These computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in a flow or flows of flowcharts or a block or blocks of block diagrams.

What described above is merely preferable embodiments of the present disclosure and is not intended to limit the scope of protection of the present disclosure.

1. A method for processing an air interface synchronization signaling, comprising:
obtaining, by a cell, a position of a sub-frame for monitoring air interface synchronization, and sending an air interface synchronization signaling of the cell at the position of the sub-frame;
wherein the sub-frame for monitoring air interface synchronization is a sub-frame of the cell, other cells receives a reference signal for air interface synchronization sent by the cell from the sub-frame.

2. The method according to claim 1, wherein the air interface synchronization signaling comprises at least one of: a layer number of the cell, cluster information of a cell cluster in which the cell is located, a position and period information of a sub-frame of a cell in each layer and this cell for monitoring air interface synchronization, a level of a timing difference between the cell and a macro cell, configuration information of a sub-frame of a multicast broadcast single frequency network (MBSFN) of the cell, off information of the cell, time-division duplex uplink/downlink (D/U) configuration information of the cell, configuration information of a reference signal (RS) for air interface synchronization, and on information of the cell;
wherein the off information of the cell refers to time information when the cell is switched to be off.

3. The method according to claim 1, wherein sending the air interface synchronization signaling through a dedicated radio resource control (RRC) message or a system information block (SIB) of a system broadcast message, or a dedicated broadcast.

4. The method according to claim 3, wherein scheduling and sending the SIB only in a sub-frame for monitoring air interface synchronization, when an air interface synchronization signaling is included in the system information block.

5. The method according to claim 3, wherein when the SIB is sent, sending a control signaling in a physical downlink control channel (PDCCH)/an enhanced PDCCH (ePDCCH) and scrambling the control signaling using an agreed radio network temporary identification (RNTI), and scheduling and sending the system information block in a physical downlink shared channel (PDSCH) according to the control signaling.

6. The method according to claim 3, further comprising:
indicating, through the PDCCH or ePDCCH, whether the air interface synchronization signaling is updated.

7. The method according to claim 3, wherein when the air interface synchronization signaling is sent using a dedicated RRC message, sending time includes that: the air interface synchronization signaling is sent for a first time, or the air interface synchronization signaling is updated.

8. (canceled)

9. (canceled)

10. The method according to claim 1, wherein when the air interface synchronization signaling is transmitted in the monitoring sub-frame, the air interface synchronization signaling is transmitted using an orthogonal frequency division multiplexing (OFDM) symbol excepting for a first or first two OFDM symbols in the monitoring sub-frame.

11. The method according to claim 1, further comprising:
when performing an RRC connection establishment for an access device, using, by the cell, a dedicated RRC message to send an air interface synchronization signaling to the small cell for a first time, wherein a sub-frame sent this time comprises a sub-frame for monitoring none air interface synchronization.

12. A method for processing an air interface synchronization signaling, comprising:
obtaining, by a small cell, a position of a sub-frame for monitoring air interface synchronization and receiving an air interface synchronization signaling from a monitoring sub-frame.

13. The method according to claim 12, comprising:
when an air interface synchronization signaling is sent through a dedicated radio resource control (RRC) message, using a configured radio network temporary identification (RNTI) to retrieve a control signaling of the dedicated RRC message in a physical downlink control channel (PDCCH)/an enhanced PDCCH (ePDCCH) of a sub-frame for monitoring air interface synchronization, and receiving the air interface synchronization signaling from a physical downlink shared channel (PDSCH) according to the control signaling.

14. The method according to claim 12, further comprising:
monitoring, by the small cell, an air interface synchronization signaling in each monitoring sub-frame, and considering that the air interface synchronization signaling is not updated when no air interface synchronization signaling belonging to the small cell is found; or
receiving, by the small cell, a reference signal from the sub-frame for monitoring air interface synchronization so as to perform an air interface synchronization process.

15. (canceled)

16. (canceled)

17. The method according to claim 12, further comprising:
sending, by the small cell, a notification that a type of an access device is a small cell, when the small cell establish an RRC connection; or
receiving, by the small cell, an air interface synchronization signaling sent for a first time through a dedicated RRC message, after establishing the RRC connection.

18. (canceled)

19. A device for processing an air interface synchronization signaling, wherein the device is a base station or a base station controller of a cell, comprising:
a first obtaining unit, configured to obtain a position of a sub-frame for monitoring air interface synchronization; and
a sending unit, configured to send an air interface synchronization signaling of the cell at the position of the sub-frame, wherein the sub-frame for monitoring air interface synchronization is a sub-frame of the cell, and other cells receive a reference signal for air interface synchronization of the cell in the sub-frame.

20. The device according to claim 19, wherein the sending unit is further configured to send the air interface synchronization signaling through a dedicated radio resource control (RRC) message or a system information block (SIB) of a system broadcast message or a dedicated broadcast.

21. The device according to claim 20, wherein the sending unit is further configured to schedule and send the system information block only in a sub-frame for monitoring air interface synchronization when an air interface synchronization signaling is included in the system information block.

22. The device according to claim 20, wherein the sending unit is further configured to send a control signaling in a physical downlink control channel (PDCCH)/an enhanced PDCCH (ePDCCH) and scramble the control signaling with an agreed radio network temporary identification (RNTI), and schedule and send the system information block in a physical downlink shared channel (PDSCH) according to the control signaling, when sending the system information block.

23-26. (canceled)

27. A device for processing an air interface synchronization signaling, wherein the device is a base station or a base station controller of a small cell, comprising:
a second obtaining unit, configured to obtain a position of a sub-frame for monitoring air interface synchronization; and
a receiving unit, configured to receive an air interface synchronization signaling from a monitoring sub-frame.

28. The device according to claim 27, wherein the receiving unit is further configured to: use a configured radio network temporary identification (RNTI) to retrieve a control signaling of the dedicated RRC message in a physical downlink control channel (PDCCH)/an enhanced PDCCH (ePDCCH) of a sub-frame for monitoring air interface synchronization, and receive the air interface synchronization signaling from a physical downlink shared channel (PDSCH) according to the control signaling, when an air interface synchronization signaling is received through a dedicated RRC message.

29. The device according to claim 27, wherein the second obtaining unit is configured to: monitor an air interface synchronization signaling in each monitoring sub-frame, and consider that the air interface synchronization signaling of the source cell is not updated, when its air interface synchronization signaling is not found.

30-34. (canceled)

35. A computer storage medium storing computer executable instructions thereon for performing a method for processing an air interface synchronization signaling, wherein the method comprises:
obtaining, by a cell, a position of a sub-frame for monitoring air interface synchronization, and sending an air interface synchronization signaling of the cell at the position of the sub-frame;
wherein the sub-frame for monitoring air interface synchronization is a sub-frame of the cell, other cells receives a reference signal for air interface synchronization sent by the cell from the sub-frame.

36. A computer storage medium storing computer executable instructions thereon for performing a method for processing an air interface synchronization signaling, wherein the method comprises:
obtaining, by a small cell, a position of a sub-frame for monitoring air interface synchronization and receiving an air interface synchronization signaling from a monitoring sub-frame.
